(19) United States
(12) Patent Application Publication
(10) Pub. No.: US 2013/0058495 A1
(43) Pub. Date: Mar. 7, 2013

(54) System and A Method For Streaming PDM Data From Or To At Least One Audio Component

(71) Applicants: Claus Erdmann Furst, Roskilde (DK); Gudmundur Bogason, Lejre (DK); Michael Deruginsky, Hillerod (DK)

(72) Inventors: Claus Erdmann Furst, Roskilde (DK); Gudmundur Bogason, Lejre (DK); Michael Deruginsky, Hillerod (DK)

(21) Appl. No.: 13/224,068

(22) Filed: Sep. 1, 2011

(51) Int. Cl. H04B 3/00

(52) U.S. Cl. 381/80

(57) ABSTRACT

An electronic circuit, a digital audio component, an interface system and a method for streaming PDM data from or to at least one audio element are provided. The electronic circuit comprises a VDD connection for receiving a VDD potential, a GND connection for receiving a potential numerically lower than said VDD potential, a CLK connection for receiving a clock signal having a high and a low part, a DATA connection for communicating said PDM data to or from a host and/or another such electronic circuit, an L/R connection for receiving a DC potential designating whether to communicate substantially synchronously with said high part or said low part of said clock signal. The electronic circuit further comprises an I/O circuit configured for communicating control data via said L/R connection.

### TECHNICAL FIELD

The present invention relates to an electronic circuit, a digital audio component, an interface system, and a method for electronic equipment, e.g. mobile telephones or laptops, in audio systems comprising digital audio components such as microphone components and/or speaker components, which digital microphone components pick up audible or other acoustic analog signals and convert them into digital electric signals, in particular PDM signals, and which digital speaker components transmit digital electric signals, in particular PDM signals and convert them into audible or other acoustic analog signals, respectively.

### BACKGROUND OF THE INVENTION

Communication technology advancements have progressed rapidly in recent years. Consumers are increasingly using electronic mobile and stationary communication comprising audio components providing audio capabilities such as head phones, speakers, microphones, amplifiers for connection with other audio equipment, television, voice recognition and the like. These components are often used in increasingly smaller equipment such as cellular phones, web-enabled cellular telephones, Personal Digital Assistants (PDA), hand-held computers, laptops, tablets such as pads, or small digital audio connectors, or any other similar devices with printed electronic circuit boards (PCBs). Using digital audio component enables an acceptable sound reproduction using electronic digital circuits and advanced signal processing.

A developing technology for portable and stationary electronic equipment involves the application of micro-electromechanical systems (MEMS) to microphones or speakers. MEMS technology enables the construction of small mechanical components on a substrate, such as a printed electronic circuit board (PCB). A microphone MEMS is generally comprised of mechanical elements 1-100 micrometers (microns) in size (0.001-0.1 mm) enabling a microphone component or assembly, generally in the size range from 1 mm to 3 mm, “glued” into a package providing housing, air cavity and protection, for a microphone element and its electronic circuitry. These audio components possess small dimensions and are, consequently, suitable for inclusion in small and/or thin electronic equipment. In this regard these audio components can be included in various types of electronic equipment and systems; such as computers e.g. desktops, laptops, notebooks, tablet computers, hand-held computers, Personal Digital Assistants (PDAs), Global Positioning systems (GPS), security systems; communication equipment e.g., cellular phones, web-enabled cellular telephones, cordless phones, pagers; computer-related peripherals e.g., printers, scanners, monitors; entertainment equipment e.g., televisions, radios, satellite radios, stereos, tape and computer disc players, digital cameras, cameras, video cassette recorders, Motion Picture Expert Group, Audio Layer 3 (MP3) players, video games; listening equipment e.g., hearing aids, earphones, headphones, Bluetooth wireless headsets, insert earphone, UWB wireless headsets; and the like. Other examples of equipment are possible. Further, providing small audio components significantly reduce or eliminate the effects of electromagnetic interference EMI. Since these audio components are small and easy to manufacture, manufacturing costs are reduced and reliability is enhanced.

PDM (Pulse Density Modulation) signals are one bit modulated digital signals used in the audio field and as defined herein are digital signals for containing an audio content. PDM is a form of modulation used to represent an analog signal such as an audio signal with digital data. In a PDM signal, specific amplitude values are not encoded into pulses as they would be in PCM (Pulse Code Modulation). Instead, it is the relative density of the bit pulses that corresponds to the analog signal's amplitude. In contrast to this, PWM (Pulse Width Modulation) is an analog signal, the width of the pulse used for indicating signal value.

Currently a commonly industrially applied de-facto interface standard (not a publicized standard) for the output of e.g. digital microphone signals is termed the PDM interface. This interface or industrial standard is characterized by its low complexity and accordingly a resulting low numbers of pins needed on the microphone component. The PDM interface of digital audio components comprises five pins and may be defined as comprising at least:

VDD: Supply voltage for the microphone component, often a definite higher potential is chosen, such as around 1-4 V, typically 1.8 V.

GND: Electrical ground potential connection for the microphone component, where GND or ground is defined as a lower voltage potential than provided at the VDD pin, e.g. such as definition of zero potential relative to the VDD potential being used. Numerical values of GND and VDD may be used in defining such lower (GND) and higher (VDD) potential.

CLK: Clock input signal for the microphone component. Often used frequency regimes comprises from 1 to 7 MHz, for example 2.4 MHz. For example, a separate external clock source or the host processor itself can generate these clocks. Often, sleep-mode operations are possible, e.g. selected by CLK signals being below 100 kHz.

DATA: Data stream output from the microphone component comprising the audio content in the form of a one bit pulse density modulated PDM signal. The output may be valid in one phase of a clock period, and in the other phase the output of DATA is tri-state, which allows an output port to assume a high impedance state in addition to the 0 and 1 logic levels, effectively removing the PDM signal from the output from the component. This allows multiple electronic circuits to share the same output line or lines. This enables e.g. two microphone components to be added to the same data wire.

L/R (Left/Right): Input selector for selecting between valid vs. tri-state clock phase, e.g. connecting L/R to VDD is often chosen to enable the high phase of the clock to assume the phase wherein data is valid and the low phase to be tri-state. Other potentials are possible, for example L/R may be hard wired to GND or another potential, which alters the clock phase in which data is valid. Thus, the microphone components can drive the PDM data on either rising edge or falling edge of the clock based on the level selected at the L/R pin. The microphone components may be clocked at double the rate of the clock for multiplexing. The digital voltage standards adhered to is known in the art when defining whether the digital levels provide a low or 0 bit or provide a high or 1 bit, some typical values are below 35% VDD is low and above 65% VDD is high.

Other potentials than VDD and GND may be used, where GND is the potential defined to be ground or zero potential, i.e. of a defined voltage value GND, which is lower than the numerical value of VDD.

A PDM interface is particularly useful when the audio component such as a microphone component is miniaturized as mentioned above, i.e. made smaller in order to comply with manufacturer and customer requests for tiny, but efficient components, because the relatively low number of connections is an advantage when soldering, incorporating or connecting such small size surface microphone component to a PCB, such as a microphone component comprising a MEMS based element, or ECM (Electret Condenser Microphone), or the like.

In order to transmit PDM signals from a microphone element, such as a MEMS microphone element, of said PDM interface, an electronic circuit is often provided integrated with the microphone element providing a microphone component. The electronic circuit can be an integrated electronic circuit, such as an ASIC (Application Specific Integrated Electronic circuit), embedded electronic circuitry, or external electronic circuit, or the like, which transforms the analog audio signal received from the microphone element, e.g. by the use of membranes and/or magnetic surfaces, into a digital audio signal to be read out from a streamed pin, e.g. the DATA pin of the PDM interface or read in, if the audio component is a speaker component, for example. The microphone component, i.e. the combination of the microphone element and the electronic circuit, is often provided alongside and/or on top of and/or inside a PCB and/or metal package housing, and incorporated into a chip with pin connections pointed outwardly from the component.

Several chip design options have been developed for providing an electronic circuit, including application-specific integrated electronic circuits (ASICs); application-specific standard products (ASSPs); and structured ASICs which comprises a combination of ASICs and FPGAs, i.e. Field-Programmable Gate Arrays.

In audio applications, digital electronic systems that provide an audio interface may be required for processor components, termed hosts, which are programmed specifically to be able to control the audio components, e.g. mode change or gain settings e.g. in transducers such as microphone components or other input elements, while at the same time being able to drive one or more speakers, amplifiers, earpieces, or other hosts or other type of output components with processed digital audio signals. In audio systems such as provided in laptops or mobile phones, digital microphone components often need to be able to communicate with a host processor in order for it to e.g. change internal gain settings or receive commands from the host, see below for a further description. The host is herein defined as a processor having digital processing capabilities. Examples of these are a CODEC or an application processor.

For a processor or host to understand which microphone component the alternate bits of the audio content belong, the microphone component's clock input pin can be connected to the serial port frame sync pin on the host and the serial port of the host run in unframed mode, for example. The data stream inside the data buffers starts from the data from this microphone component, and the software routines or coding of the host are written such that data from different microphone components are processed separately. By selecting the CLK phase appropriately, the component from which the PDM data originates is selected. This is one example of how to set up the PDM interface to accommodate host processing, others ways are known in the art.

At present, solutions have been suggested to provide such control data capabilities by digital audio interface types such as the SLIMbus or I2S+I2C interface standards in connection with a host. These standards allow mutual component and host-component control data communication. However, they tend to be rather complex. A large number of mobile and stationary equipment manufacturers have taken part in the workgroups to develop the SLIMbus interface, which interface supports many digital audio components simultaneously, and carries multiple digital audio data streams at differing sample rates and bit widths. The clock frequency is very high, i.e. 28 MHz, providing a high capacity enabling control of several microphone components, and several, for example twenty four, speaker components, but at the expense of an increased switching loss.

The addition of more than two audio components to a host requires more connection pins being used, which works contrary to the trend of miniaturizing the microphone or speaker element itself. Thus, many industry manufacturers and sub-contractors have not always taken to the new more complex interface standards and still apply the PDM interface for audio components. Accordingly, within the digital audio field, an alternative to the SLIMbus and I2S+I2C interface is needed which provides communication alternatives but also takes into consideration the trend to miniaturize audio components.

### SUMMARY OF THE INVENTION

In the following, digital microphone components, such as a microphone element in combination with an electronic circuit, will be discussed in relation to the invention. It is however clear, that the invention can be applied to other areas as well, in which these types of mutually communicating electronic circuitry or components are applicable using audio or other sensor input and output systems, such as applied to digital speakers, digital receivers or earpieces, amplifiers, such also as integrated with e.g. a speaker element or component, and hosts and the like.

The term “audio component” is defined in this text as comprising at least one electronic circuit, such as a digital electronic circuit, and at least one audio element. The term “component” is not to be limited to comprise only devices provided integrally in one device, but also includes components integral to a system. The term “audio element” is not limited to a microphone element or a speaker element only. The audio component may also comprise a package.

In an embodiment there is provided an electronic circuit for streaming PDM data from or to at least one audio element.

Said electronic circuit may comprise a VDD connection for a receiving a VDD potential, such as a supply potential, a GND connection for receiving a potential numerically lower than said VDD potential, a CLK connection for receiving a clock signal having a high and a low part. It at least comprises a DATA connection for communicating said PDM data to or from a host and/or another such electronic circuit, and an L/R connection for receiving a DC potential designating whether to communicate substantially synchronously with said high part or said low part of said clock signal. The term “substantially synchronously” is reflecting the fact that either slight delay or overlay may be permitted, depending on the audio element in question and the response time of the system as a whole, wherein the electronic circuit is being applied. A synchronous communication is preferred, however, alternatively or additionally, asynchronous communication is possible and may be applied where suitable.

Said electronic circuit further comprises an I/O circuit configured for communicating control data via said L/R connection.

An advantage lies in the fact that the inventive electronic circuit is then able to provide an audio component with the same communication abilities as the much more complex interface standard SLIMbus is able to do. Further, the present PDM interface standard is followed by the inventive electronic circuit and not altered, which keeps constant the number of connection pins needed from the microphone component. Thus, a low pin count allows the electronic circuit to be applicable to and advantageous to use with small sized audio elements providing small sized audio components such as MEMS microphone components. Accordingly, the inventive electronic circuit provides the possibility of being used for back-fitting an audio component by including an electronic circuit according to the invention in a PDM interface, i.e. the component is backwards compatible.

There is thus provided an electronic circuit, which enables a hitherto not realizable combined PDM and data communication interface for audio components, which provides control data on a first pin, i.e. the L/R connection pin, and provides the streamed audio data on another second pin, different from said first pin, e.g. the DATA connection pin.

The relatively low number of pins necessary is thus in line with the PDM interface, namely five, and the connection pins are basically available, supplying/receiving the same content. This is a distinct advantage of the electronic circuit according to the invention compared to e.g. the SLIMbus interface. Being a more complex solution sending out another audio format, and not the PDM format, it is thus both more expensive to implement, and requires more digital logic inside audio component and host. It uses one extra pin for identification of each particular microphone component. The SLIMbus interface provides both streamed audio data and control data on the same pin and this in reality makes this interface standard de-facto unsuitable for implementation because industry still relies on and implements the PDM-standard in generally available printed circuits, such as cards or chips, or inside components.

The electronic circuit enables further development into communication possibilities between a host and an audio component, such as gain control, and data exchange, such as mode setting.

By the invention, it has also been realized that two or more audio elements or components may also be connected in mutual relation using an electronic circuit according to the invention to communicate, e.g. interchange data, control each other or one another, e.g. by defining a master/slave, or by treating the other audio component as a host. As is evident from above, the presently available known components delivering a PDM interface is entirely audio content delivering and can not be used to communicate control data between one microphone component and other microphone components and/or a host.

With the present invention, it has surprisingly been realized that the inventive electronic circuit is able to perform such control data communication due to the fact that the AC level and the DC level have been separated out on different pins.

Known art is available, wherein other pins different from the L/R pin of the PDM interface have been adapted for control data. In a first attempt, the DATA pin has been used to transmit such binary, digital control data by overlaying the streamed digital PDM data with control data. In a second attempt, the control data has been transmitted by modulating the CLK signal, which is modulated according to the control data being transmitted. A disadvantage is of course, that such attempts are not compatible with the PDM standard, and thus not backwards compatible. Furthermore, they require the addition of further analog electronic circuitry upon the audio component in order to separate the CLK and control data, e.g. a clock recovery circuit, which generally tend to be relative large in physical size on the board. In this scheme it is also only possible to send data from the host to the devices. Thus, digital communication between two devices or from a device to a host is not possible with these two attempts.

As far as applicant is aware the inventive approach of the present application of separating the DC and the AC level on different pins on the bus has not been suggested before in the audio component field, maybe because the problem and solution mentioned above has not been recognized before now.

Selecting the L/R pin is not a obvious choice for communicating digital control data, because this selector pin is usually regarded as being suitable for a dedicated purpose namely to change modulation by having two states of operation, selecting the switching from high to low (or low to high) phase on the DATA channel.

The inventive electronic circuit indeed fulfills a real need in the market, because, as mentioned above, previously the audio equipment producer had only a choice between either a) having a low number of pins to connect and no data communication enabled, which in consequence hindered a more sophisticated communication between an audio component and a host, or b) having a higher number of pins to connect during production enabling data communication, which was not compatible with the trend of miniaturizing audio components, or was not taking into consideration the industry prevalence for using the PDM interface.

In an embodiment of said electronic circuit, said I/O circuit is configured for communicating control data by transmitting and/or receiving control data. When transmitting control data, the electronic circuit is further suitable to operate as a host, controlling or informing other components, such as another host, or another electronic circuit according to the invention, or another digital component. When receiving, the electronic circuit may be controlled from the outside, such as by a host and/or other electronic circuit.

In an embodiment of said electronic circuit, said I/O circuit comprises an I/O cell comprising logic elements for enabling said communication of control data. These logic elements may in their basic form be logic components, such as OR, AND, NOR, NAND gates and combinations thereof. However, a driver circuit may be also or alternatively be provided. Simple communication tasks may thus be solved, such as providing hand shake, error handling, digital signal receiving and transmitting capabilities.

In an embodiment of said electronic circuit, said I/O cell comprises a processor. More advanced handling of data and communication thereof may then be provided, e.g. using an embedded processor or other type of logic element.

In an embodiment of said electronic circuit, it is comprised in or comprises an ASIC. ASIC's are specific for its use, and may be provided in a suitable smaller physical size, suitable performance, and suitable positioning in relation to the audio element, it is adapted for use with. Several chip design options have been developed for providing an electronic circuit, including application-specific integrated electronic circuits (ASICs); application-specific standard products (ASSPs); or structured ASICs.

In an embodiment of said electronic circuit, it further comprises a random number generator. This random generator may be used for an enumeration process for identifying each audio component comprising an electronic circuit according to the invention to a host or other such audio component. Preferably, the size of the number available on the random number generator is selected according to maximum number of circuits anticipated for each host. The generator address space is then larger than the total number of addresses provided by the number of devices to be included in the electronic device to be built, e.g. the random generator may be a 16 bit generator. Then the probability of each electronic circuit to provide identical ID numbers to at least one other electronic circuit during the enumeration process is kept low, even with a larger number of electronic circuits, e.g. more than two, such as eight circuits present in the electronic device, e.g. on the printed circuit board.

In another embodiment of the electronic circuit, the random number generator is provided by the output of an analog sigma-delta modulator provided in the electronic circuit. Other types of random number generators are known in the art and may be employed also. Using a sigma-delta modulator or a pseudo random generator to provide the random number is an advantage, because these elements are provided anyway, which reduces the size and total number of electronic elements needed in the electronic circuit, which is in particular an advantage when the audio element is small in physical size, such as a MEMS element, for example.

The term “number” of the random generator is here used in a general way, and is not intended as to be limited to integers only, but may also comprise letters, signs, symbols, machine code or the like.

In another embodiment, the random number generator is a pseudo random noise generator where the initial condition, also called the seed, of the pseudo random noise generator is controlled by an analog noise source. This assures that the pseudo random sequence is uncorrelated, e.g. from one audio component to a similar type audio component. In this way, the generated ID numbers from any two electronic circuits will at a high probability not be identical. It may an advantage to be based on an analog noise source as this is an advantageous way to assure uncorrelated random process from one audio component to any other like audio component. According to applicant's experience, similar components comprising similar “random” number generators more often than is statistically coincidental provide similar random number results. Examples of components having or being analog noise sources are resistors and semiconductor components e.g. bipolar transistors, CMOS transistors, diodes, varactors and the like, e.g. provided externally from the audio component or internally within it. It may also comprise the DC/AC elements as mentioned below.

In an embodiment of said electronic circuit, said control data comprises at least one ID number, comprising a fixed and/or random ID number. Thus, the electronic circuit may be used for identification of the electronic circuit itself and the audio component, it is provided with. A fixed ID number may be provided e.g. during manufacture or may be assigned to the device from a host, during use.

In an embodiment of said electronic circuit, it comprises a memory configured for storing at least said fixed and/or random ID number provided from said random number generator. Thus, a specific or random ID number may be stored in this memory for the electronic circuit in question. It may alternatively or further be able to store other information, e.g. relating to version, other audio components ID number, or in general all data relating to enabling the communication between audio components and host(s), such as gain settings, filter coefficients, data or parameters concerning microphone/speaker, such as name of producer, calibration mode sensitivity, date of production, power consumption and the like.

In an embodiment of said electronic circuit, it further comprises a conversion circuit for converting from a PDM data stream to an analog signal or vice versa from an analog signal to a PDM data stream. Accordingly, the circuit may be suitable either for a microphone or speaker, respectively. In an embodiment of said electronic circuit, said conversion circuit is configured for A/D conversion (input is analog e.g. for a microphone element) or D/A conversion (input is digital e.g. for a speaker element).

In an embodiment of said electronic circuit, said I/O circuit is configured for enabling mutual communication between said electronic circuit and at least one other such electronic circuit. Thus, a combination of two or more electronic circuits may now be realized, such as sets or groups of two, for accommodating two or more audio components or elements, which are e.g. mutually gain controlled or are provided with one identical ID-number or two sets of ID-numbers, which reduces the load on a host regulating the sets of components. Several ways of enumeration is possible, see below.

In a further aspect there is provided a digital audio component for streaming PDM data from or to at least one audio element, comprising at least one electronic circuit according to the invention configured for connection to at least one host and/or at least one other audio component, and at least one audio element being connected to said at least one electronic circuit. As mentioned above, such digital audio component is backward compatible with the current PDM interface. Thus, it enables a provision of an interface by said audio component, which is backwards compatible with the current PDM interface, because it has the same number of connection pins. Thus, the audio component provides the ability to have communication between microphone/speaker/amplifier components and a host processor and/or between microphone/speaker/amplifier components. This indeed fulfills a real need in the market.

According to an embodiment of said audio component said at least one electronic circuit is also configured for transmission of an audio signal to be converted into a PDM data stream and/or for reception of a PDM data stream to be converted into an audio signal. The same or a connected electronic circuit, such as an improved ASIC, is then able to handle both the control signal and the audio data signal in the form of a digital PDM signal.

According to an embodiment of said audio component the at least one audio element comprises at least one of a speaker element, a microphone element, an amplifier element, a processor element, such as a host, and any combination thereof. Thus, presently available elements and future developments of audio elements are presumed suitable at this point. Co-modular audio components comprising one or more audio elements are thus also anticipated, where this may prove suitable.

According to an embodiment of said audio component, the audio element comprises a MEMS device or an ECM device. A miniaturized or relatively physically small device or audio component may then be realized, i.e. in the scales of having surface areas less than from 1 mm to 3 mm. The PDM interface having a limited number of pins or legs, five in all, is then better suited for use with such audio component.

According to an embodiment of said audio component, the L/R connection of the audio component is connectable to VDD or GND via at least one DC element or is able to be left floating, and the L/R connection of the audio component is further connectable to a control data port of a host and/or to the L/R connection of at least one other such audio component and/or to the L/R connection of at least one electronic circuit via at least one AC element. This electronic configuration enables a single audio element to be in control data communication with a host/audio component/electronic circuit, as is suitable for that specific application of the audio component.

According to an embodiment, there is provided a combination or a set of at least two audio components according to the invention, comprising a first audio component and a second audio component, wherein the L/R connection of the first audio component is connectable to VDD via at least one first DC element, the L/R connection of the second audio component is connectable to GND via at least one second DC element, the L/R connection of the first audio component and the L/R connection of the second audio component are connectable to each other via at least one AC element, and the L/R connection of the first audio component or the L/R connection of the second audio component is further connectable to the control data port of the host or to a third audio component or electronic circuit.

An advantage comprises the fact that during production of the PCB comprising such double or more combinations of audio components, each L/R connection of each audio component may be pre-connected for easy assembly on the board. The two or more audio components may be provided integrally or individually, wherein an integral provision further eases the assembly process, and the individual provision is made possible and easy due to the connection of the two L/R connections to each other. The term “component” is used here not limited to a singular housing, but also applies to a single audio component in a housing comprising e.g. two or more audio elements such as two similar or different such elements or to a PCB comprising two or more elements integrated with further electronics.

According to an embodiment there is provided a multitude of such sets of two audio components. By connecting the audio elements or audio component in pairs of two, each of the two components are able to be individually identified given the setup of PDM interface used, and thus as many audio component as is needed for that specific application is available simply by providing such multitude of inventive audio components in sets of two, and combining with the DC/AC elements.

According to an embodiment of said audio component, there is provided an audio component or at least two audio components, further comprising an integrated host, such as an application processor or CODEC. Thus, an integrated component is available, wherein the audio interface from one or two audio elements is provided with the integral processor, which is then connectable to any digital electronic circuitry and programmable for the specific application in which the audio component is meant to be included in. Easy adaptability and data communication is then to be implemented, by selecting the correct number of pins needed when producing electronic equipment with several audio components.

According to an embodiment of said audio component, the audio component is configured to be connectable to a host, which is programmed specifically for communicating said control data. According to an alternative embodiment of said audio component, the audio component is configured to be connectable to a host, which is not programmed specifically for communicating said control data. The user of the audio component is accordingly able to choose whether he likes to program the host in such a way, that the host is able to receive/transmit the control data from the L/R pin of each and/or both audio components. Thus, even conventional hosts without specific programming are able to be used in conjunction with audio components according to the invention. This provides a very useful inventive interface to cooperate with conventional, not-specifically programmed hosts and/or existing audio devices and electronic equipment, which fact expands the regime of back-fitting the audio component to existing systems/equipment. For example, if the host is not programmed specifically, each audio component transmits its unique ID number. The host will not respond to this hand raise, and does not provide any answer. Then the audio component may be set up to stream PDM data, e.g. right away, or e.g. after a preset listening-cycle, e.g. up to from between 32 and 100 clock cycles.

In a further aspect of the invention, there is provided an interface system for streaming PDM data from or to at least one audio element, comprising at least one audio component according to the invention, and a host or another audio component or electronic circuit comprising a control data port, wherein the L/R connection of the at least one audio component is connected to VDD or GND via at least one DC element or is left floating, and the L/R connection of the at least one audio component is connected to the control data port of the host or another audio component or electronic circuit via at least one AC element.

In a further embodiment, the interface system comprises at least two audio elements in each their audio component, a first and a second audio component, wherein the L/R connection of the first audio component is connected to VDD via at least one first DC element, the L/R connection of the second audio component is connected to GND via at least one second DC element, the L/R connection of the first audio component and the L/R connection of the second audio component are connected to each other via at least one AC element, and the L/R connection of the first audio component or the L/R connection of the second audio component is further connected to the control data port of the host or another audio component or electronic circuit.

In a further embodiment, there is provided an interface system comprising four audio elements in each their audio component, a first, a second, a third, and a fourth audio component, and a host comprising a control data port, wherein the L/R connection of the first and third audio component are mutually connected to VDD via at least one DC element, the L/R connection of the second and fourth audio component are mutually connected to the mutual L/R connection of the first and third audio component via at least one AC element, and the mutual L/R connection of the second and fourth audio component is connected to the control data port of the host or another audio component or electronic circuit.

Alternatively, there is provided an interface system comprising at least four audio elements in each their audio component, a first, a second, a third, and a fourth audio component, wherein the L/R connection of the second and fourth audio component are mutually connected to GND via at least one DC element, the L/R connection of the first and third audio component are mutually connected to the mutual L/R connection of the second and fourth audio component via at least one AC element, and the mutual L/R connection of the first and third audio component is connected to the control data port of the host or another audio component or electronic circuit.

Thus, there is provided a simple, yet versatile bus, which utilizes lower power than e.g. the SLIMBus interface, which is backwards compatible with the PDM interface because it requires no extra pins, which apart from each audio component being added may be provided using only two further e.g. external components and one digital I/O, and which enables an easy enumeration process. Further, any suitable number of audio components may be attachable to a host using the inventive system.

Making the tradeoffs between the AC element's reactance, i.e. capacitive or inductive values, the DC element's resistive value and the frequency content is not a trivial task, e.g. if the current is drawn from the communication interface. It has been realized, that when providing such control data pin using the L/R connection, the L/R pins do not react positively be tied directly to GND or VDD, without the resistance/reactance elements in between, respectively, because this tends to short out the PDM communication pin. Such pullup/pulldown resistive element may be provided externally from the pin, or may additionally or alternatively be provided internally, i.e. inside the pin within the electronic circuit itself.

The idea is to connect L/R to VDD or GND via a DC element such as a resistor, and to couple the L/R connections, and the input/output of the host together via an AC element, such as a capacitor. This results in adding only a few extra external components. Further, it enables an enumeration process which without any additional pins enables a uniquely identification of the physical connection of the components.

Further, one may easily and simply add more singular or pairs of microphone or speaker or amplifier or host components or elements without having to add further additional electronics, such as capacitors or resistors or the like to the interface system.

One advantage is that the audio components can act as an autonomous system not needing a host in order to communicate mutually.

In a further embodiment of the interface system, the host is programmed specifically or is not programmed specifically for communicating said control data. The audio component then enters a backwards compatible PDM mode.

In a further embodiment of the interface system the at least one DC element and/or the at least one AC element is a cutoff filter. Thus, the cutoff filter parameters comprising AC and DC elements, such as e.g. C, (L), R, and power consumption may be selected appropriately for providing a stable control data transmittance, either sending or receiving.

In a further embodiment, the system further comprises a bias control or block. In particular when servicing e.g. two similar or different audio components or elements, the system may be configured for providing I/O data on the control data line on the L/R pins, which are configured for cooperation with presently available I/O-voltage standards for digital logic electronic circuitry, such as a host controller.

In a further aspect, there is provided a method for streaming PDM data from or to at least one audio element, comprising providing at least one electronic circuit according to the invention, said method comprising connecting said at least one electronic circuit to said at least one audio element thus providing at least one digital audio component, providing the VDD connection receiving a VDD potential, providing the GND connection receiving a potential numerically lower than said VDD potential, providing the CLK connection receiving a clock signal having a high and a low part, providing the DATA connection communicating said PDM data from or to said at least one audio element to or from a host and/or another such electronic circuit, providing the L/R connection receiving a DC potential designating whether to communicate substantially synchronously with said high part or said low part of said clock signal, and further providing an I/O circuit communicating control data via said L/R connection.

In a further embodiment of the method, it further comprises connecting the L/R connection of said at least one electronic circuit or digital audio component to a host or another audio component or electronic circuit comprising a control data port.

In a further embodiment of the method, it further comprises connecting the L/R connection of said at least one electronic circuit or said at least one audio component to VDD or GND via at least one DC element or is leaving it floating, and connecting the L/R connection said at least one electronic circuit or said at least one audio component to a control data port of a host or another audio component or another electronic circuit via at least one AC element.

In a further embodiment of the method, it further comprises providing at least two audio components, a first and a second audio component, connecting the L/R connection of the first audio component to VDD via at least one first DC element, connecting the L/R connection of the second audio component to GND via at least one second DC element, and connecting the L/R connection of the first audio component to each other via at least one AC element, and connecting the L/R connection of the first audio component or the L/R connection of the second audio component to the control data port of the host or another audio component or electronic circuit.

In an embodiment of the method, it comprises a cutoff filtering. In an embodiment of the method, it comprises a bias control of the control data.

In a further embodiment of the method, there is performed a Media Access Control on each control data pin, e.g. a 1-persistent Carrier Sense Multiple Access (CSMA), which is a probabilistic Media Access Control (MAC) protocol in which e.g. a single node (bit) verifies the absence of other traffic before transmitting on a shared transmission medium, such as an electrical bus. This may be an advantage because of its simplicity. It is an advantage for CSMA to be performed in order to ensure that units do not transmit at the same time.

In a further embodiment of the method, there is further performed an error check on the control data. Thus, there is an increased probability that a receiving unit such as a host will therefore eventually receive correct data.

In a further embodiment of the method, the electronic circuit according to the invention generates a random and/or fixed ID number, and sends this ID number via the L/R connection to a host or another audio component or another electronic circuit. In an advantageous embodiment of the method, this is performed after power up and before PDM audio signal operation of at least one of said audio elements or components. An advantage is that during startup of an electronic device comprising audio components, the host or other processor, e.g. a central processor, may be quickly, e.g. in about after a few milliseconds, and correctly be informed as to which type of component is ready and available.

In a further embodiment of the method, in case of an address conflict, the host repeats the process, until all audio components which are in communication with said host, have been provided an audio component specific unique number. This can also be performed by the audio component by itself or by another audio component and/or electronic circuit. In a further embodiment of the method, each audio component specific unique number is stored in the memory of said electronic circuit.

In a further embodiment of the method, all of the audio components are synchronously clocked by a host or an audio component or electronic circuit adapted thereto. This eases the signal processing performed subsequently and also reduces the number of processing units needed to process the audio data and the control data received from or transmitted to the audio component.

In a further embodiment of the method, gain control is performed upon each individual audio component, and/or each set of audio components. This enables automatic level control (ALC) and analog mixing, e.g. controlled by one host for several audio components, or individually, which is possible when each audio component has been separately identified towards that host.

### BRIEF DESCRIPTION OF THE DRAWINGS

For a more complete understanding of the disclosure, reference should be made to the following detailed description and accompanying schematic drawings wherein like reference numerals denote like parts:

FIG. 1A shows in a side view an audio component according to prior art, comprising an electronic circuit and a MEMS microphone element,

FIG. 1B shows a microphone component according to prior art comprising a MEMS microphone element and an electronic circuit, configured to be connectable to a host using the five PDM interface pins: DATA, L/R, CLK, VDD, and GND,

FIG. 1C shows data lines clocked in a PDM stream according to an example of prior art,

FIG. 2 shows a diagram of an exemplary setup of different components in electronic equipment according to prior art,

FIG. 3 shows a physical layer of an audio component for streaming PDM data according to an embodiment of the invention,

FIG. 4 shows a physical layer of an interface system for streaming PDM data according to an embodiment of the invention, wherein the system further comprises a BIAS block, which is not enabled,

FIG. 5 shows an example of a BIAS block as in FIG. 4 implementing sink and source enabling,

FIG. 6 shows a physical layer of an interface system for streaming PDM data according to an embodiment of the invention, wherein the component further comprises an enabled BIAS block,

FIG. 7 shows a graph of the control data voltage as a function of time, describing the power up phase, the enumeration process phase, and the ready or operational phase for the interface system,

FIG. 8A shows a microphone component according to an embodiment of the invention comprising an electronic circuit according to an embodiment of the invention configured to be connectable to a host or another audio component,

FIG. 8B shows a speaker component according to an embodiment of the invention configured to be connectable to a host or another audio component,

FIG. 9 shows a total of four microphone components according to an embodiment of the invention connectable to a host in an interface system according to an embodiment of the invention, and

FIG. 10 shows a frame setup of a data link layer with CLK layer, DATA bits layer and encoded bits layer.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required.

### DETAILED DESCRIPTION

While this disclosure is susceptible to various modifications and alternative forms, certain embodiments are shown by way of example in the drawings and these embodiments will be described in detail herein. It will be understood, however, that this disclosure is not intended to limit the invention to the particular forms described, but to the contrary, the invention is intended to cover all modifications, alternatives, and equivalents falling within the spirit and scope of the invention defined by the appended claims.

As mentioned above, the SLIMbus is a more complex interface solution than the PDM interface, requiring a data pin for each microphone pair being connected to this bus and one extra pin for identification of each particular microphone. The PDM interface, i.e. the Pulse Density Modulation interface presently used for audio applications does not support such microphone communication.

A digital PDM bit stream is encoded from an analog signal through the process of e.g. delta-sigma modulation. This process uses a one bit quantizer that produces either a 1 or 0 depending on the amplitude of the analog signal. A 1 or 0 corresponds to a full scale signal.

For the processor or host to understand which microphone component the alternate bits belong, the microphone component's clock, which is often one half of the clock at which the serial port is running, is connected to the serial port frame sync pin of the host and the serial port in run in unframed mode. The serial port starts receiving the data from the first rising edge of the microphone component's clock, and this will be the data from that microphone component whose L/R select pin is shorted to VDD. This means that the microphone component drives the data on the rising edge of the clock. So, in all cases, the data stream inside the data buffers starts from the data from this microphone component, and the software routines are written such that data from different microphone components are processed separately.

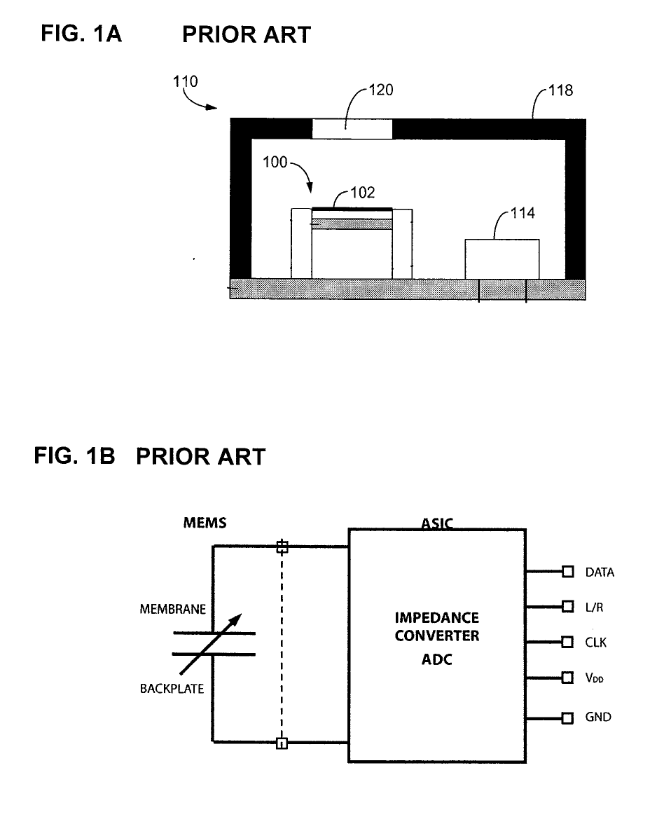

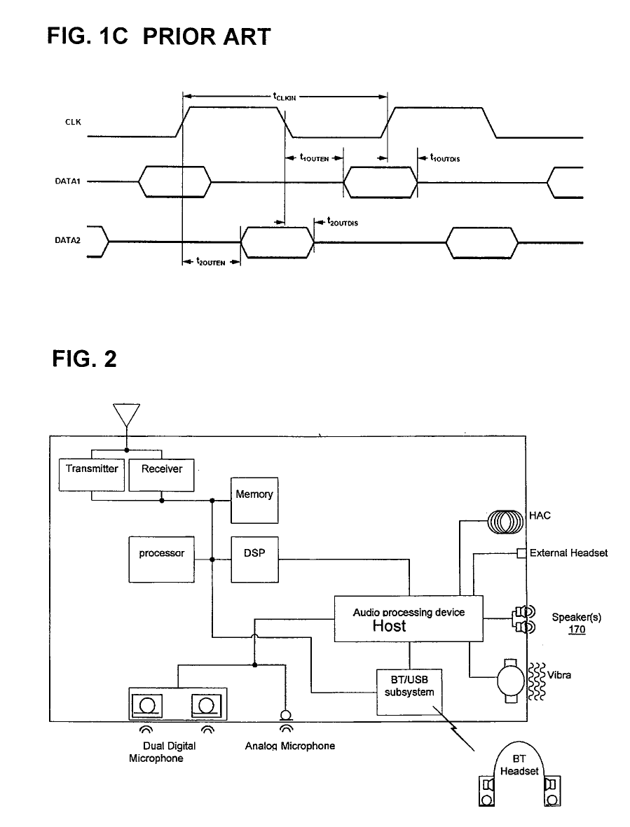

A microphone component comprises an audio element 110 such as a MEMS microphone element and an electronic circuit, see FIG. 1A, where is shown a MEMS microphone element in a physical side view, wherein there is provided a bottom hole microphone 100 in a small size chip comprising circuitry in order for the combined audio component 110 to be integrated or in other ways provided upon a PCB and communicate audio data, PDM style. Due to the limited size, a limited number of connections or pins may be applied to such audio component. The MEMS microphone element includes a base and a first e.g. membrane structure 102 disposed upon the base. A second structure 118 is disposed on the first structure and the second structure is configured to form a first cavity and has at least one side wall attached to the first structure. At least one MEMS 100 is disposed in the cavity and a first acoustic port 120 is formed through the sidewall. The first acoustic port 120 provides a passageway to allow sound energy to enter the MEMS audio element to be processed by the audio circuitry. The MEMS microphone component 110 may comprise a single MEMS element or a dual MEMS element and further electronic circuit 114. A MEMS microphone component, or its package is often termed simply a “MEMS” in daily terms, but will in order to avoid confusion herein be referred to as a MEMS microphone component.

FIG. 1B shows an audio component according to prior art applying the PDM interface, comprising a MEMS microphone element and an electronic circuit in the form of an ASIC, comprising five pins in total: A VDD, a DATA, a CLK, an L/R and a GND pin, and provides a digital PDM signal containing an audio or sound content on the DATA pin.

In FIG. 1C, as an example, is shown modulated PDM data and CLK of a prior art MEMS microphone component, to be interfaced to a host or processor over a serial port on the latter. The microphones can drive the PDM data on either rising edge or falling edge of the clock based on the logic level at the L/R pin. Interfacing a single microphone component is performed by providing the same clock in the range of 1 to 4 MHz to the microphone component and the serial port and receive the PDM data into the processor from the serial port, while keeping the L/R pin tied to GND or VDD. To connect two such microphone components to a single serial port data line, the L/R pin of one microphone component may be grounded directly. The L/R pin of the other microphone component is connected directly to VDD. This ensures that the microphone components drive data on opposite edges of clock. To make the serial port receive data from both microphone components, the microphone components may to be clocked at half the rate of the clock at which the serial port is running. The microphone component modulates audio signals with respect to the clock fed to it. For a two-microphone component interface, the data inside the receive buffer will be interlaced bit by bit. This means that every alternate bit belongs to the same microphone component. The timing of data driven by the microphone components in prior art with respect to the clock is based on the L/R pin of the microphone component according to one use of the PDM interface pins. If the L/R pin is tied to the GND pin, the data is driven on the rising edge of the clock. If the L/R pin is tied to VDD pin the data is driven on the falling edge of the clock.

In FIG. 2 is shown electronic audio equipment e.g. a PDA comprising several audio elements, such as digital or analog speakers, headsets and microphones.

Said equipment may advantageously be fitted or retro-fitted with one or more electronic circuits according to the invention for each audio element, subsidiary audio components according to the invention in a system according to the invention providing the alternative interface system described in the following.

There is provided an electronic circuit for streaming PDM data from or to at least one audio element. Said electronic circuit comprises a supply connection for a receiving a VDD potential, herein called a VDD connection, a ground connection, herein called a GND connection for receiving a potential numerically lower than said VDD potential, a clock connection, herein called a CLK connection for receiving a clock signal having at least a high and a low part, a DATA connection for communicating said audio data in PDM format to or from a host and/or another such electronic circuit, and an L/R connection for receiving a DC potential designating whether to communicate substantially synchronously with said high part or said low part of said clock signal. Said electronic circuit further comprises an I/O circuit configured for communicating control data via said L/R connection. Said control data may be digital signals adapted such that a host or another component may be able to interpret these data, e.g. such as digital ID numbers identifying the audio component, and/or logic signals for pulling or pushing host commands, or the like, and/or digital information otherwise conceived to improve communication with the host or other component, as it is known in the art.

A digital audio component for streaming PDM data from or to at least one audio element comprises at least one electronic circuit according to the invention configured to be connectable to a host and/or at least one other audio component, and wherein said at least one audio element is connected to said electronic circuit for transmitting the audio signal to be converted into a PDM data stream and/or for receiving the PDM data stream to be converted into an audio signal.

An interface system for streaming PDM data from or to at least one audio element, comprising at least one audio component according to the invention, further comprising a host comprising a control data port, wherein the L/R connection of the at least one audio component is connected to VDD or GND via at least one DC element, and the L/R connection of the first audio component is connected to the control data port of the host via at least one AC element.

Accordingly, the L/R pin is in an embodiment connected to a cutoff filter in order to stabilize the electric voltage potential Vo as seen in FIG. 1. The interface system is characterized by a physical layer, as well as a data link layer, as discussed elsewhere herein.

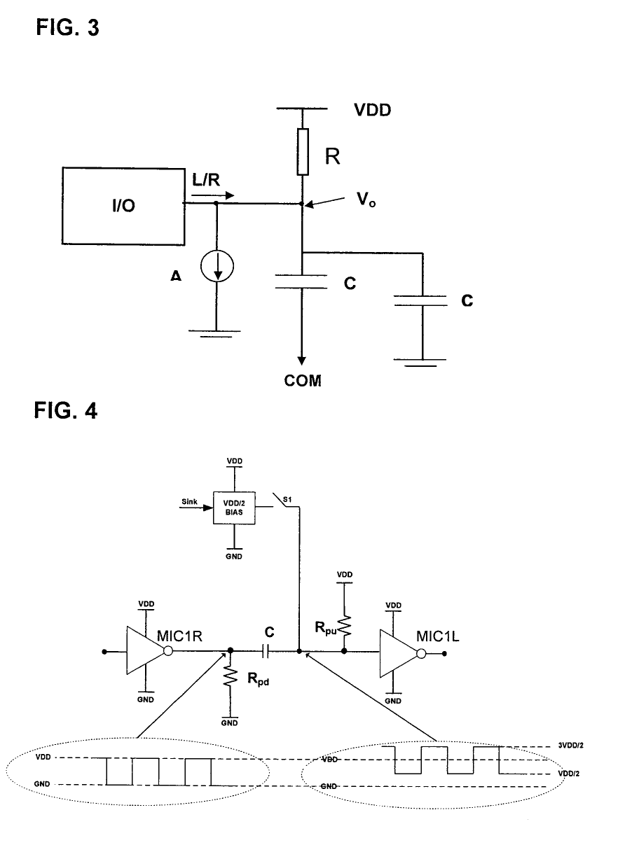

In FIG. 3 is shown a physical layer for an embodiment, wherein the L/R pin is pulled high to Vo by connecting it to an electrical potential VDD higher than GND through an external DC element, a resistor R, then termed pullup resistor with a predetermined resistor value. Alternatively, the L/R pin could be left floating or be pulled low by connecting it to the electrical potential GND through the same or different value resistor R, thus termed pulldown resistor. As observed from the electronic circuit diagram of FIG. 3, it is disadvantageous to tie the L/R connection directly to GND or VDD, because this will lead to a shortening of this pin, i.e. effectively shortening the communication channel.

In FIG. 3 the microphone element I/O that is pulled high is connected to the COM port of a host (not shown) through an AC element. The AC element is a capacitive element, i.e. an external capacitor C with a predetermined capacitance and/or inductance value. Thus, the communication interface to transmit or receive control data overlays the DC levels at the L/R pins with the transmitted sequence.

Thus, FIG. 3 shows a cutoff filter having a time constant and a cutoff frequency. In order to determine or select the values of the reactance, i.e. capacitance C and the resistance, i.e. the resistor value R, there are some considerations to make in general for the system: a) The static current consumption A when pulling the L/R pin to Vo by VDD or GND or another potential, b) the startup time selected for the system for settling of the L/R value, i.e. startup time after a power up, and c) the resulting cutoff filter frequency depending on the bus application and communication speed possible or desired for the system and/or for the communication COM to or from the host.

The capacitance c shown in FIG. 3 is an indication of parasitic capacitance often associated with such digital electronic circuits, e.g. when provided on boards, which c typically may be in the order of from about 10 to about 500 pF.

Typical values used for supplying such a cutoff filter can be a current consumption in the order of lower than 100 microampere, preferably lower than 50 microampere, most preferred around 5 to 10 microampere. Startup times can be chosen according to application, e.g. for example in order to coordinate the startup time to correspond to the startup times applying to the host, e.g. such that the first signals from the audio component reach the host either before, at the same time or after the host has powered up. Startup times for settling to the L/R potential value varies, but can be in the order of often less than 100 milliseconds. Selected resulting frequency content of such a bus may lie in the order of about 100 kHz.

Example values for a cutoff filter: Corresponding values of A, startup time, and thus C and R for supplying a cutoff filter as shown in FIG. 3 may then be selected as follows: Current consumption 10 microampere, startup times from about 5 to 10 milliseconds. The cutoff filter frequency settled by the values of the C and R is preferably is not high, which allows the bus to communicate, so a cutoff around 10 kHz is used as an example. This leads to for example a pullup/pulldown resistor R value of 100 kilo ohm, resulting in a maximum power consumption corresponding to around VDD/2, if the peak to peak value of the signal values of the bus is equal to VDD. So if VDD=1.8 V, then the current consumption is 9 microampere. If a smaller signal swing is chosen, a lower current consumption is the result. If the cutoff frequency is chosen to 1 kHz, this leads to a capacitor value of 1.6 nF. The time constant of the filter will then be 100 kHz×1.6 nF=160 microseconds. For a 1% settling error this means that the resulting settling time will be about 737 microseconds, i.e. both the settling time and the cutoff frequency will be approximately be two decades lower.

Several other solutions, as it is well known in the art, are available for floating or pulling the L/R pins, e.g. by other filter types and/or signal control circuits. It may however be an advantage to provide such a simple yet effective cutoff filter in order to reduce component and equipment production costs, and at the same time yet provide for advanced data communication between e.g. audio component and host.

As such AC coupling of the filter tend to remove the DC value and centers the COM signal VDD/2 around either VDD or GND, in an embodiment of the interface system, it further comprises a bias control or block, which is preferable when e.g. there is provided two audio elements, either within one component or as two separate audio components each comprising one audio element. This is in order to provide the COM signal in a form, which standard hosts are able to read, i.e. standard digital I/O signal or full scale signal.

FIGS. 4-7 show an example of how such a bias control may be configured between two audio components, e.g. similar audio components MIC 1 L and MIC 1 R.

FIG. 4 shows, in the lower part thereof, how the COM signal from MIC 1 L is shifted VDD/2 after the cutoff filter so as to be centered around VDD instead of around VDD/2. The DC potential is here pulled towards VDD with a pullup resistor Rp, in the receiving end. The bias block VDD/2 is provided as shown in the upper part of the FIG. 4, however it is not enabled, illustrated by the switch S1 left open. Other ways to provide such bias control are known in the art, e.g. using purely resistive components.

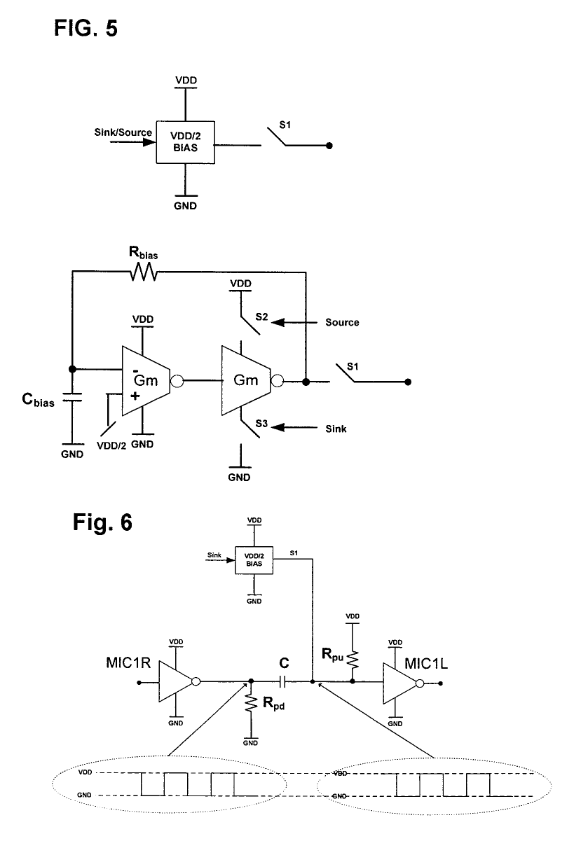

In the present case, as shown in FIG. 5, there is provided a bias block diagram element, as shown in the upper part of the figure, comprising for example the elements as described in the lower part of the figure. The bias block comprises a voltage controlled current source controlled by a low frequency loop. The differential transconductance stage, Gm, compares the VDD/2 with the low pass filtered version of the output, and thereby accordingly adjusts the voltage to the Gm stage, that will either Sink or Source current. The DC value of the bus can for example be extracted with a RC filter, C_{bias} and R_{bias}, which time constant is selected to be large as not to affect the COM signaling on the bus. The ability of the bias block to shift to Sink or Source current can then be controlled by the switches S2 and S3, inserted between VDD and GND, respectively, on the Gm stage. E.g. if the bias block is to be in Source mode, such as if the bus is pulled to ground potential with an external resistor, then switch S2 can be closed and switch S3 can be opened. In case of Sink mode the opposite applies.

During implementation of such bias block by closing switch Si, see FIG. 6, there is at the lower part of the figure shown how the signal COM at the receiving end is shifted to be centered around VDD/2, when the bias block is enabled by closing the switch s1. In this case where a pull-up resistor is added to the bus then the bias block is provided in Sink mode. In the opposite case, where a pulldown resistor is added, then the bias block is provided in source mode. This configuration assures that several bias blocks can be coupled in parallel without causing a conflict.

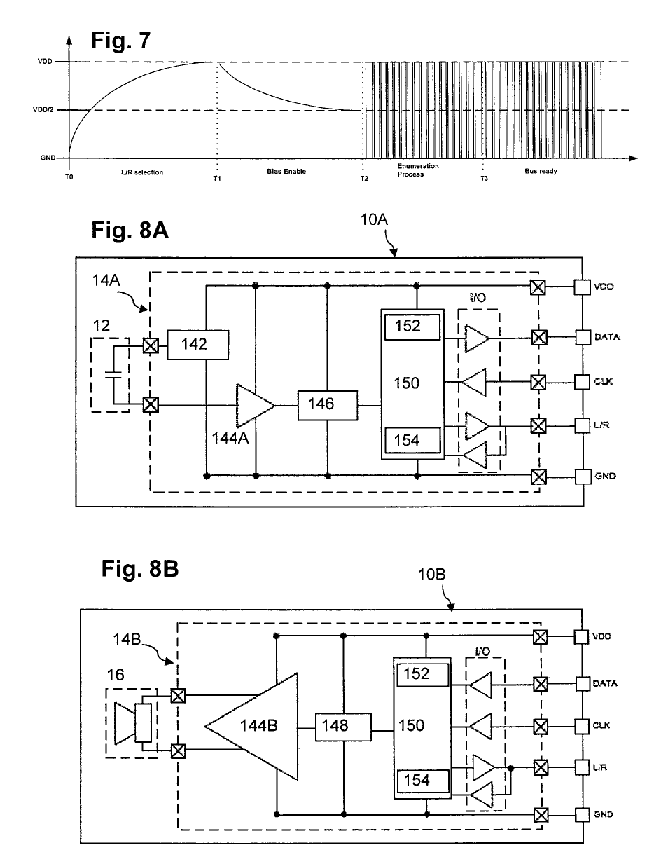

In FIG. 7 is shown how the COM signal on the bus at the receiving end varies over time from a system provided with an enabled bias block, i.e. S1 closed. Firstly, there is a short period starting from T0 in which the audio component powers up. After T1 is a phase wherein the L/R selection is provided for the two elements/components, during which period the bias block has been enabled, then at T2 it enters the enumeration process phase, and after T4 finally the bus is ready to send/receive the COM signal or signals. T1, T2, T3 and T4 may be selected appropriately according to type of component, host or PDM data content, and may be in the order of about 1 ms to 1000 ms, such as 100 milliseconds.

In FIGS. 8A and 8B are shown exemplary audio components according to the invention, a microphone component 10A and a speaker component 10B, respectively. In FIG. 8A the microphone component 10A comprises a microphone element 12 and an electronic circuit 14A according to the invention providing five pin connections as defined above, a VDD, a DATA, a CLK, an L/R and a GND pin, and provides a digital PDM signal containing an audio or sound content on the DATA pin. In FIG. 8B the speaker component 10A comprises a speaker element 16 and an electronic circuit 14B according to the invention providing five pin connections as defined above, a VDD, a DATA, a CLK, an L/R and a GND pin, and provides a digital PDM signal containing an audio or sound content on the DATA pin. The PDM signal is here received from the host to the DATA pin as opposed to in FIG. 8A, where the PDM signal is transmitted from the DATA pin to the host.

In FIG. 8A, the electronic circuit 14A according to the invention, which in an advantageous embodiment comprises an ASIC, comprises a charge pump 142 connected to a first output leg of the microphone element 12, an amplifier 144A connected to a second output leg of the microphone element 12, to provide entry points of the analog signal from the microphone element 12. The electronic circuit further comprises an A/D converter, such as a sigma-delta modulator 146, connected to the amplifier 144 for converting the output analog signal from the microphone element 12 to the digital PDM signal streamed to a host (not shown) from the DATA pin. The protocol block 150 comprises in an embodiment a memory 152 and a random number generator 154. The block 150 is via I/O ports connected to control data on the L/R pin, and is thus configured for control data communication, e.g. receiving and/or transmitting control data from a host (not shown) or another audio component according to the invention.

In FIG. 8B, the electronic circuit 14B according to the invention, which in an advantageous embodiment comprises an ASIC, comprises a pre-amplifier 144B, connected to the first and second input leg of a speaker element 16 to provide exit points of the analog signal to the speaker element 16. The electronic circuit further comprises a D/A converter 148, connected to the pre-amplifier 144B for converting the input streamed digital PDM signal going to the speaker element 16 and provided to the speaker component/electronic circuit from a host (not shown) over the DATA pin into an analog signal. As in FIG. 8A, the protocol block 150 comprises in an embodiment a memory 152 and a random number generator 154. The block 150 is via I/O ports connected to control data on the L/R pin, and is thus configured for control data communication, e.g. receiving and/or transmitting control data from a host (not shown) or another audio component according to the invention.

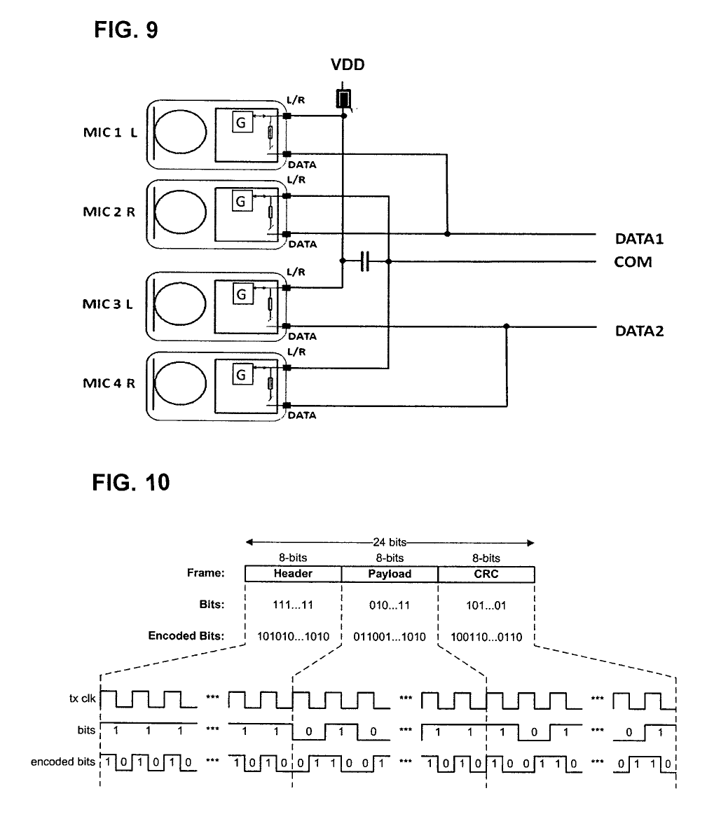

In FIG. 9 is shown a schematic diagram of an embodiment where the inventive electronic circuit and/or audio component are connected in an audio component system. FIG. 9 shows a system according to an embodiment of the invention connecting a combination of two sets of audio components, e.g. four similar digital miniaturized microphone components of the MEMS type, to a host.

FIG. 9 shows, e.g. in a first combined set, similar type microphone components MIC 1 L and MIC 2 R according to the invention are combined for streaming PDM data from each component onto a common DATA1 port on a host (not shown). In a second combined set, similar type microphone components MIC 3 L and MIC 4 R according to the invention are combined for streaming PDM data from each component onto a common DATA2 port on the same or another host (not shown). The PDM data is streamed to the host according to the L/R pins selection. The L/R pins of the components MIC 1 L and MIC 3 L, respectively, are pulled to a common first electrical potential, VDD using a common DC element R. Further, the L/R pins of the components MIC 2 R and MIC 4 R, respectively, are pulled to a common second electrical potential on a first side of an AC element, a capacitive element C, the opposite side of which is connected to the first electrical potential VDD. This in effect provides a cutoff filter configuration. By providing control data on each of the L/R pins provided, such a configuration allows for control data to be sent by each audio component individually and received by a host or vice versa for further processing. This system configuration thus allows for individual data communication between a host and each audio component. It should also be noted, that as many further audio components 5 . . . N as one likes may be added to the system, provided there are N number of signal data ports or data ports (DATA N) on the host or hosts in the system. This accordingly requires a minimum of connection operations such as soldering operations to be made by the equipment producer, when assembling the audio system. Also, the external electronic AC and DC elements are readily available in commerce. Alternatively or alongside, other filtering setups may be provided as known in the art, which provides such stable pulling of the potentials to different levels.

In fact, by the invention, there is provided an alternative PDM interface, i.e. an extension of the currently applied PDM interface, enabled by an electronic circuit according to the invention, where the L/R connection is also used as a communication interface, while at the same time making the audio component backwards compatible to the current PDM interface standard. The current PDM interface works by either connecting L/R to VDD or to GND. This use of the L/R connection for control data allows the audio component, e.g. a microphone component, to be backward compatible with the prior arts PDM interfaces. Backwards compatible can also be understood to mean that an electronic circuit or an audio component according to the invention can co-operate alongside non-inventive audio components implementing the known PDM interface, i.e. they send no control data on their L/R pin, with little or no modification.

A number of audio components and a single host may communicate using the same protocol on a serial bus, where one or more components and a host in general terms are called a communication unit. Any two units can communicate directly using Point-to-Point communication, where each unit on the bus has an unique address for this, such as the component may be assigned e.g. address 1 . . . 14, and the host is assigned address 0, where the address is assigned to the components during an enumeration process, se below. Thus, any unit can communicate with all other components at once using broadcasting, e.g. address 15 is used to indicate this.

Other examples of audio elements which may be part of an audio component according to the invention include but not exclusively a speaker element, a receiver element, a MEMS based silicon receiver element, a dual receiver element, an electret microphone element, a dynamic microphone element, a MEMS based silicon microphone element, a dual microphone element, a conjoined microphone and receiver element, depending on the desired applications. The electronic circuit according to the invention may be an integrated electronic circuit (IC), e.g. an ASIC of any suitable type, and may comprise at least one or combinations thereof of the selection of an amplifier, a capacitor, a resistor, an inductor, or other passive element, digital I/O ports, D/A and A/D converters, logic ports, programmable elements, and the like depending on the desired application. It will be understood that one or more audio elements and one or more electronic elements may be included in an audio component according to the invention. The audio element and the electronic circuit may be integrated into a single chip. Alternatively, the audio element may be connected to the electronic circuit by wires or welds or otherwise as known in the art.

In FIG. 10 is shown an example of how a frame structure of the control data in the data link layer of an electronic circuit and a method according to an embodiment of the invention may be embodied, wherein there is provided a flag or header for signaling start of frame of 8 bits, payload for address, control and data of 8 bits, and a CRC for error detection of 8 bits, as described herein.

Line encoding is performed, as the frame data is to be transmitted through e.g. capacitors in the physical layer. Any DC signal content (low frequency content) in the frame data may be removed to avoid baseline wandering. This is achieved by encoding the frame data, using one of the following schemes: the more complex 8B/10B encoding or Manchester encoding.

8b/10b is a line code that maps 8-bit symbols to 10-bit symbols to achieve DC-balance and bounded disparity, and yet provide enough state changes to allow reasonable clock recovery. This means that the difference between the count of 1s and 0s in a string of at least 20 bits is no more than 2, and that there are not more than five 1s or 0s in a row. This helps to reduce the demand for the lower bandwidth limit of the channel necessary to transfer the signal.

Manchester code (also known as Phase Encoding, or PE) is a line code in which the encoding of each data bit has at least one transition and occupies the same time. It therefore has no DC component, and is self-clocking, which means that it may be inductively or capacitively coupled, and that a clock signal can be recovered from the encoded data.

Carrier Sense Multiple Access (CSMA) is a probabilistic Media Access Control (MAC) protocol, in which a node verifies the absence of other traffic, before transmitting on a shared transmission medium, such as an electrical bus, or a band of the electromagnetic spectrum. “Carrier Sense” describes the fact that a transmitter uses feedback from a receiver that detects a carrier wave before trying to send. That is, it tries to detect the presence of an encoded signal from another station before attempting to transmit. If a carrier is sensed, the station waits for the transmission in progress to finish before initiating its own transmission. “Multiple Access” describes the fact that multiple stations send and receive on the medium. Transmissions by one node are generally received by all other stations using the medium.

In an embodiment of the method according to the invention, there is performed a Media Access Control, e.g. a 1-persistent CSMA. This may be attractive here because of its simplicity. It is an advantage for CSMA to be performed in order to ensure that units do not transmit control data at the same time.

A number of units communicate together using a single line, e.g. conveniently the existing L/R pin. It is an advantage, that any unit may initiate a transmission at any time without any overall coordination. To keep things simple Time-Division-Multiplexing (TDM) such as provided for in the SLIMbus standard is not used, otherwise it may be possible also to apply this. However, this is conveniently not necessary here, since control data (event based) and audio data (real-time streaming) is not mixed into a single bus.

A cyclic redundancy check (CRC) may be performed, which is an error-detecting code designed to detect accidental changes to raw computer data, and is commonly used in digital networks and storage devices such as hard disk drives. A CRC-enabled component calculates a short, fixed-length binary sequence, known as the check value or (improperly) the CRC, for each block of data to be sent or stored and appends it to the data, forming a codeword. When a codeword is received or read, the component either compares its check value with one freshly calculated from the data block, or equivalently, performs a CRC on the whole codeword and compares the resulting check value with an expected residue constant. If the check values do not match, then the block contains a data error and the component may take corrective action such as rereading or requesting the block be sent again, otherwise the data is assumed to be error-free, although, with some small probability, it may contain undetected errors; which is the fundamental nature of error-checking.

In an embodiment of the method according to the invention, there is further performed an error check on the control data. In FIG. 10 is shown an example of the frame structure of the control data in an electronic circuit and a method according to an embodiment of the invention, wherein there is provided a flag or header for signaling start of frame of 8 bits, payload for address, control and data of 8 bits, and a CRC for error detection of 8 bits. Error is detected by using the CRC field of the frame. RX checks for errors in received frame and ignores it if it contains error. A receiving unit senses the same signal as the transmitting unit, where the transmitting unit will re-transmit as long as it detects errors. Thus, a receiving unit will therefore eventually receive correct data. Alternative or other error checks are available in the art, which may be performed on the system and by the method according to the invention.

All of the audio components on the bus may be synchronously clocked by the host, where the transmit clock (TX) is derived from the host clock (SCK) by an integer ratio, and the receive clock (RX) is derived from another clock, e.g., the serial clock (SCK) by an integer ratio. The clock may alternatively be received from a clock device, another host or another audio component or electronic circuit.

A special consideration when building audio system equipment enabling interface communication is the enumeration process in which each microphone component is provided with a unique address, e.g. linked to its specific physical position on the board, i.e. on the electronic device comprising the audio system. This is not only part of an identification process as known in the art generally, wherein components announce themselves as being present. This is also directly related to the exact physical position of each component in relation to the other audio components on the board and in relation to the sound source, such as the person using the electronic device. This is an advantage, because when performing the subsequent signal processing by the host of the signals from each component, such as reduction of noise levels or removal of echo, an acceptable result is provided when the physical position of each component is known, i.e. distance, up or down, left or right from each other, size and gain, and in particular in relation to a sound source.

One may illustrate this position enumeration process by looking at a school class, in which it is not only important, that each pupil (or component) identifies itself by name (ID number), but also that each pupil lifts his hand (send ID number) when called out to, such that the teacher (host) may be able to see, where the pupil is sitting, what his/her name is, and what who he/she is and is capable of, such that the teacher (host) may use or test or place the pupil (component) according to the teachers desires.

In order to identify the exact physical position i.e. the identity of each component the host may mute all components except for one. This then enables the host to indentify to which data line the component is connected and on which clock phase. This is repeated until connectivity for all components have been identified.

As an alternative each audio component mutes itself until a random time after power up. This random time can be set by a random generator in each audio component. When the audio component becomes present, i.e. by starting to transmit PDM data then the host then assigns an address by sending out a command on the bus that the audio component that just became present has been assigned a specific address.

In an embodiment, e.g. during startup, each microphone component according to the invention, e.g. the electronic circuit thereon or therein, generates a random identification number, e.g. by the utilization of a random number generator, such as a 16 bit generator, and sends this via the L/R connection to a host. In case of an address conflict, the host repeats the process until all audio components, which are in communication with said host, have an audio component specific unique number.

In an advantageous embodiment, the random number generator is provided by the output of the analog sigma-delta modulator, which is already present in the electronic circuit. Thus, the number of elements in the electronic circuit is kept low. Further, it has been noticed, that if all audio components are fitted with the same type of random number generator, they tend to provide at least some component ID numbers, which are similar. Thus, the sigma-delta provides a random signal, which is more than suitable for this application.

In an embodiment of the method, there is provided a random generation of component address. Each component or electronic circuit contains e.g. a 16 bit random generator which is used to generate a 16 bit address. In case of conflict the host restarts the enumeration process. After each component has obtained a unique address this address in mapped to e.g. the address space between 1-14 by first muting all components and then enabling them one by one the exact physical connection can be determined. Each audio component or electronic circuit now has a unique address linked directly to a physical connection.

The random generator is in an embodiment a pseudo random noise generator where the initial condition of the pseudo random generator is controlled by an analog noise source, such as a DC element, such as a diode, transistor and/or resistor.

In an alternative method the enumeration process comprises to have a random generator for determining an audio component to become present on the bus. After becoming present on the bus the host assigns an address to each audio component, e.g. between 1-14, starting with the lowest value.

In case two components becomes present on the bus at the same time with the same address or ID number the host will ask them to repeat the process. By first muting all components and then enabling them one by one the exact physical connection can be determined. Each component now has a unique address linked directly to a physical connection.

While the present disclosure is susceptible to various modifications and alternative forms, certain embodiments are shown by way of example in the drawings and these embodiments will be described in detail herein. It will be understood, however, that this disclosure is not intended to limit the invention to the particular forms described, but to the contrary, the invention is intended to cover all modifications, alternatives, and equivalents falling within the spirit and scope of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. An electronic circuit for streaming PDM data from or to at least one audio element, said electronic circuit comprising:
a VDD connection for a receiving a VDD potential, such as a supply potential,
a GND connection for receiving a potential numerically lower than said VDD potential, a CLK connection for receiving a clock signal having a high and a low part,
a DATA connection for communicating said PDM data to or from a host and/or another such electronic circuit,
an L/R connection for receiving a DC potential designating whether to communicate substantially synchronously with said high part or said low part of said clock signal,
wherein said electronic circuit further comprises an I/O circuit configured for communicating control data via said L/R connection.

2. The electronic circuit according to claim 1, wherein said I/O circuit is configured for communicating control data by transmitting and/or receiving control data.

3. The electronic circuit according to claim 1, wherein said I/O circuit comprises an I/O cell comprising logic elements for enabling said communication of control data.

4. The electronic circuit according to claim 1, wherein said I/O cell comprises a processor.

5. The electronic circuit according to claim 1, which is comprised in or is comprising an ASIC.

6. The electronic circuit according to claim 1, further comprising a random number generator.

7. The electronic circuit according to claim 6, the size of the number available on the random number generator is selected according to maximum number of circuits anticipated for each host.

8. The electronic circuit according to claim 7, wherein the random number generator is provided by the output of an analog sigma-delta modulator provided in the electronic circuit.

9. The electronic circuit according to claim 8, wherein the random number generator is a pseudo random noise generator, where the initial condition of the pseudo random noise generator is controlled by an analog noise source.

10. The electronic circuit according to claim 1, wherein said control data comprises at least one ID number, comprising a fixed ID number and/or a random ID number.

11. The electronic circuit according to claim 1, further comprising a memory configured for storing at least said fixed and/or random ID number provided from said random number generator.

12. The electronic circuit according to claim 1, further comprising a conversion circuit for converting from a PDM data stream to an analog signal or vice versa from an analog signal to a PDM data stream.

13. The electronic circuit according to any of the preceding claims, wherein said I/O circuit is configured for enabling mutual communication between said electronic circuit and at least one other such electronic circuit.

14. An digital audio component for streaming PDM data from or to at least one audio element, comprising
at least one electronic circuit configured for connection to at least one host and/or at least one other audio component, and
at least one audio element being connected to said at least one electronic circuit.

15. The audio component according to claim 14, wherein said at least one electronic circuit is also configured for transmission of an audio signal to be converted into a PDM data stream and/or for reception of a PDM data stream to be converted into an audio signal.

16. The audio component according to claim 14, wherein the at least one audio element comprises at least one of a speaker element, a microphone element, an amplifier element, a processor element, such as a host, and any combination thereof.

17. The audio component according to claim 14, comprising a MEMS or an ECM.

18. The audio component according to claim 14, wherein the L/R connection of the audio component is connectable to VDD or GND via at least one DC element or is able to be left floating, and the L/R connection of the audio component is further connectable to a control data port of a host and/or to the L/R connection of at least one other such audio component and/or to the L/R connection of at least one electronic circuit via at least one AC element.

19. The audio component according to claim 14, further comprising an integrated host, such as an application processor or CODEC.

20. The audio component according to claim 14, wherein the audio component is configured to be connected to a host, which is programmed specifically for communicating said control data.

21. The audio component according to any of the claims 14 to 20, wherein the audio component is configured to be connected to a host, which is not programmed specifically for communicating said control data.

22. A system of at least two audio components, the system comprising:
a first audio component and a second audio component, and wherein:
the L/R connection of the first audio component is connectable to VDD via at least one first DC element,
the L/R connection of the second audio component is connectable to GND via at least one second DC element,
the L/R connection of the first audio component and the L/R connection of the second audio component are connectable to each other via at least one AC element, and
the L/R connection of the first audio component or the L/R connection of the second audio component is further connectable to the control data port of the host or to a third audio component or electronic circuit.

23. The system of claim 22 further comprising at least one set of two electronic audio components.

24. An interface system for streaming PDM data from or to at least one audio element, comprising at least one audio component, and a host or another audio component or electronic circuit comprising a control data port, wherein
the L/R connection of the at least one audio component is connected to VDD or GND via at least one DC element or is left floating, and
the L/R connection of the at least one audio component is connected to the control data port of the host or another audio component or electronic circuit via at least one AC element.

25. The interface system according to claim 24 comprising at least two audio elements in each their audio component, a first and a second audio component, wherein
the L/R connection of the first audio component is connected to VDD via at least one first DC element,
the L/R connection of the second audio component is connected to GND via at least one second DC element,
the L/R connection of the first audio component and the L/R connection of the second audio component are connected to each other via at least one AC element, and
the L/R connection of the first audio component or the L/R connection of the second audio component is further connected to the control data port of the host or another audio component or electronic circuit.

26. The interface system according to claim 24 comprising at least four audio elements in each their audio component, a first, a second, a third, and a fourth audio component, wherein
the L/R connection of the first and third audio component are mutually connected to VDD via at least one DC element,
the L/R connection of the second and fourth audio component are mutually connected to the mutual L/R connection of the first and third audio component via at least one AC element, and
the mutual L/R connection of the second and fourth audio component is connected to the control data port of the host or another audio component or electronic circuit;
Or the L/R connection of the second and fourth audio component are mutually connected to GND via at least one DC element,
the L/R connection of the first and third audio component are mutually connected to the mutual L/R connection of the second and fourth audio component via at least one AC element, and
the mutual L/R connection of the first and third audio component is connected to the control data port of the host or another audio component or electronic circuit.

27. The interface system according to claim 24, wherein the host is programmed specifically or not programmed specifically for communicating said control data.

28. The interface system according to claim 24, wherein the at least one DC element and/or the at least one AC element is comprised in a cutoff filter.

29. The interface system according to any of the claims 24 to 28, further comprising a bias control or block.

30. A method for streaming PDM data from or to at least one audio element, the method comprising:
providing at least one electronic circuit,
connecting said at least one electronic circuit to said at least one audio element thus providing at least one digital audio component,
providing the VDD connection receiving a VDD potential,
providing the GND connection receiving a potential numerically lower than said VDD potential,
providing the CLK connection receiving a clock signal having a high and a low part,
providing the DATA connection communicating said PDM data from or to said at least one audio element to or from a host and/or another such electronic circuit,
providing the L/R connection receiving a DC potential designating whether to communicate substantially synchronously with said high part or said low part of said clock signal, and
further providing an I/O circuit communicating control data via said L/R connection.

31. The method according to claim 30, further comprising connecting the L/R connection of said at least one electronic circuit or digital audio component to a host or another audio component or electronic circuit comprising a control data port.

32. The method according to claim 31, further comprising connecting the L/R connection of said at least one electronic circuit or said at least one audio component to VDD or GND via at least one DC element or is leaving it floating, and connecting the L/R connection of the at least one audio component to the control data port of a host or another digital audio component or another electronic circuit via at least one AC element.

33. The method according to claim 31, further comprising providing at least two audio elements in each their audio component, a first and a second audio component, and connecting the L/R connection of the first audio component to VDD via at least one first DC element, connecting the L/R connection of the second audio component to GND via at least one second DC element, and connecting the L/R connection of the first audio component and the L/R connection of the second audio component to each other via at least one AC element, and connecting the L/R connection of the first audio component or the L/R connection of the second audio component to the control data port of the host or another audio component or electronic circuit.

34. The method according to claim 31 further comprising a cutoff filtering.

35. The method according to claim 31 further comprising a bias control.

36. The method according to claim 30, in which there is performed a Media Access Control.

37. The method according to claim 31, in which is further performed an error check on the control data.

38. The method according to claim 31, wherein the electronic circuit generates a random and/or fixed ID number, and sends this ID number via the L/R connection to a host or another audio component or another electronic circuit.

39. The method according to claim 38, wherein this is performed after power up and before PDM audio signal operation of at least one of said audio elements or components.

40. The method according to claim 39, wherein, in case of an address conflict, the host repeats the process, until all audio components, which are in communication with said host, have been provided an audio component specific unique number.

41. The method according to claim 40, wherein each audio component specific unique number is stored in the memory of said electronic circuit.

42. The method according to claim 31, wherein all of the audio components are synchronously clocked by said host or an audio component or electronic circuit adapted thereto.

43. The method according to any of the claims 30 to 42, wherein gain control is performed upon each individual audio component, and/or each set of audio components.
